(19) United States
(12) Patent Application Publication
(10) Pub. No.: US 2019/0279513 A1
(43) Pub. Date: Sep. 12, 2019

(54) VEHICLE CONVOYING USING SATELLITE NAVIGATION AND INTER-VEHICLE COMMUNICATION

(71) Applicant: Peloton Technology, Inc., Mountain View, CA (US)

(72) Inventors: Austin B. Schuh, Los Altos, CA (US); Stephen M. Erlien, Mountain View, CA (US); Joshua P. Switkes, Mountain View, CA (US); Stephan Pleines, San Mateo, CA (US); John L. Jacobs, Bonny Doon, CA (US); Michael OConnor, Redwood City, CA (US)

(73) Assignee: Peloton Technology, Inc., Mountain View, CA (US)

(21) Appl. No.: 16/184,866

(22) Filed: Nov. 8, 2018

Related U.S. Application Data
(63) Continuation-in-part of application No. 15/590,715, filed on May 9, 2017.
Application No. 15/590,715 is a continuation-in-part of application No. PCT/US06/00167, filed on Jan. 4, 2006.
(60) Provisional application No. 60/641,296, filed on Jan. 4, 2005.

(51) Int. Cl. G08G 1/00; G05D 1/02; G01S 19/52; G01S 19/51

(52) U.S. Cl. CPC G08G 1/22; G01S 19/51; G01S 19/52; G05D 1/0295

(57) ABSTRACT

The system and methods comprising various aspects of the invention described herein disclose the coordination the platooning vehicles, including embodiments in which the same subset of satellite signals from a GNSS is used by all platooning vehicles to determine coordinates for position, relative position, and/or velocity. By using a uniform set of satellites for navigation calculations, discrepancies between the systems on different vehicles can be reduced, and a more uniform accuracy is achieved, allowing more predictable platooning.

### CROSS-REFERENCE TO RELATED APPLICATIONS

This application is a continuation in part of U.S. patent application Ser. No. 15/509,715, which in turn is a continuation in part of PCT/US/060167, which claims the benefit of U.S. Provisional Patent Application Ser. No. 62/249,898, filed Nov. 2, 2015. Applicant claims the benefit of priority of each of the foregoing applications, all of which are incorporated herein by reference.

### FIELD OF THE INVENTION

This application relates generally to methods, systems and devices that improve safety, diagnostics, analytics and fuel savings systems for vehicles, including but not limited to enabling at least a second vehicle to follow, safely, a first vehicle at a close distance in an automated or semi-automated manner. More particularly, the present invention relates to methods, systems and devices that permit vehicles to coordinate platooning using inter-vehicle, wireless, and satellite signals.

### BACKGROUND

The present disclosure relates to systems and methods for enabling vehicles to closely follow one another safely through partial automation, also known as platooning. More specifically, the systems and methods disclosed herein relate to the enablement of platooning by coordinating the navigation information from a Global Navigation Satellite System (GNSS), such as the Global Positioning system (GPS) or the European Galileo system.

Platooning can have significant fuel savings benefits, but is generally unsafe when done manually by a driver. By using semi-automated vehicular convoying systems that utilize vehicle-to-vehicle (V2V) communication channels (such as a Digital Short Range Communications (DSRC) link) to connect the two vehicles, control the distance or gap between them, and to communicate upcoming actions (such as braking events) from a lead vehicle to a following vehicle, the convoying system can automatically command the following vehicle to react faster (by, for example, braking) than a human driver could respond. Therefore, semi-automated vehicular convoying systems can enable vehicles to follow closely together in a safe, efficient, convenient manner. Platooning can be especially useful for tractor-trailer trucks, where the fuel savings benefit can be significant.

For the enablement of platooning, the two linked vehicles also coordinate navigation information, which contributes to maintaining a predetermined gap between the vehicles. As platooning may be authorized only on certain routes or sections of highways, both vehicles need accurate information about their locations to platoon safely. Vehicles commonly use receivers for a Global Navigation Satellite System (GNSS), such as the Global Positioning system (GPS) or the European Galileo system, to identify their locations. However, the navigation coordinates for the platooning vehicles may have discrepancies if the vehicles use different satellites to determine their respective coordinates. There is therefore a need for improvement in the platooning coordination of vehicles by use of coordinated navigation information.

### SUMMARY

The system and methods comprising various aspects of the invention described herein disclose the coordination the platooning vehicles, including embodiments in which the same subset of satellite signals from a GNSS is used by all platooning vehicles to determine coordinates for position, relative position, and/or velocity. By using a uniform set of satellites for navigation calculations, discrepancies between the systems on different vehicles can be reduced, and a more uniform accuracy is achieved, allowing more predictable platooning.

In some embodiments, each platooning vehicle determines which satellites of the GNSS it can view, and then broadcasts that information to the all the other vehicles in the platoon using the V2V communication link. Each vehicle in the platoon then determines which satellites signals can be commonly detected by all vehicles in the platoon, and proceeds to use only that subset of satellites in determining coordinates for position, relative position, and/or velocity.

In some embodiments, the information about which satellites are in view is passed to a single vehicle in the platoon, which then determines which subset of satellites are common to all vehicles, and then redistributes that information back to the other vehicles in the platoon.

In some embodiments, each vehicle transmits the information about which satellites are in view to a remote network operations center (NOC). The determination of which satellites are common for the platooning vehicles is then made at the NOC, and the resulting list of common satellites is transmitted back to the platooning vehicles.

It will be appreciated by those skilled in the art that the various features of the present invention described herein can be practiced alone or in combination. These and other features of the present invention will be described in more detail below in the detailed description of the invention and in conjunction with the following figures.

### BRIEF DESCRIPTION OF THE DRAWINGS

In order that the present invention may be more clearly ascertained, some embodiments will now be described, by way of illustration, with reference to the accompanying drawings, in which:

FIG. 1A shows a lead vehicle and a following or trailing vehicle at a first stage of platooning: available to platoon.

FIG. 1B shows a lead vehicle and a following or trailing vehicle at a second stage of platooning: linking.

FIG. 1C show a lead vehicle and a following or trailing vehicle at a third stage of platooning: linked.

FIG. 2 shows a variety of communications links between platooning vehicles, ancillary vehicles, wireless transceivers, and a network operations center.

FIG. 3 illustrates a variety of factors that a central server, such as maintained at a NOC, might consider in determining candidates for linking.

FIG. 4A illustrates in simplified form an embodiment of a control system onboard a vehicle for managing communications as well as monitoring and controlling various vehicle functions.

FIG. 4B illustrates in simplified form an algorithm, operating on the onboard control system of FIG. 4A, by which a lead vehicle issues commands to and receives data back from a proximately-located following vehicle.

FIG. 5 illustrates in simplified form a variety of types of messages sent between the NOC and the vehicles, together with simplified architectures for the onboard system and the NOC.

FIG. 6A illustrates in block diagram form the operation of a platooning supervisor system, comprising a vehicle monitoring and control system in combination with one or more software layers, in accordance with an embodiment of the invention.

FIG. 6B illustrates in greater detail an embodiment of the processors, sensors and actuators of the vehicle monitoring and control system of FIG. 6A, together with the associated software layers.

FIG. 7A illustrates in greater detail the Platooning Supervisor Layer of FIG. 6A.

FIG. 7B illustrates, from a software functionality perspective, the operation of an embodiment of the vehicle control system of the present invention.

FIG. 8 illustrates in flow diagram form an embodiment of a vehicle data processing main loop in accordance with the invention.

FIG. 9 illustrates in flow diagram form an embodiment of NOC-vehicle communications management.

FIG. 10 illustrates in flow diagram form an embodiment of a process for coordination and linking in accordance with the invention, including consideration of factors specific to the vehicles.

FIG. 11 illustrates an embodiment of software architecture suited to perform the travel forecasting function that is one aspect of the present invention.

FIG. 12 illustrates a pair of vehicles traveling in close proximity to one another, and the GPS satellites seen by each.

FIG. 13A illustrates in flow diagram form various alternative processes for ensuring that vehicles traveling in close proximity to one another and using GPS position information rely on such position information from the same satellites.

FIG. 13B illustrates in flow diagram form various alternative processes for ensuring that vehicles traveling in close proximity to one another and using GPS position information rely on such position information from the same satellites.

FIG. 13C illustrates in flow diagram form various alternative processes for ensuring that vehicles traveling in close proximity to one another and using GPS position information rely on such position information from the same satellites.

FIG. 14 shows an alternative approach for monitoring relative vehicle position among vehicles traveling in close proximity to one another, when the number of viewable satellites is fewer than normally desired.

FIG. 15 shows in flow diagram from an embodiment of a process for evaluating vehicle position where, as shown in FIG. 14, the number of viewable satellites is less than normally desired.

### DETAILED DESCRIPTION OF THE INVENTION

The present invention will now be described in detail with reference to several embodiments thereof as illustrated in the accompanying drawings. In the following description, numerous specific details are set forth in order to provide a thorough understanding of embodiments of the present invention, including the description of a plurality of different aspects of the invention, including, in some cases, one or more alternatives. It will be apparent to those skilled in the art that the invention can be practiced without implementing all of the features disclosed herein. The features and advantages of embodiments may be better understood with reference to the drawings and discussions that follow.

The present invention is described in relation to systems and methods for automated and semi-automated vehicular convoying, sometimes also called platooning. Such systems enable vehicles to follow closely behind each other, in a convenient, safe manner. For convenience of illustration, the exemplary vehicles referred to in the following description will, in general, be large trucks, but those skilled in the art will appreciate that many, if not all, of the features described herein also apply to many other types of vehicles and thus this disclosure, and at least some of the embodiments disclosed herein, is not limited to vehicles of any particular type. Those skilled in the art will also recognize that the methods disclosed herein for using GPS data to coordinate multiple vehicles that are connected through V2V communication may be used regardless of whether the vehicles are engaged in convoying or platooning or are even capable of platooning.

Platooning systems often provide for, among other things:

1) a close following distance to save significant fuel;
2) safety in the event of emergency maneuvers by the leading vehicle;
3) safety in the event of component failures in the system or either vehicle;
4) an efficient mechanism for identifying partner vehicles with which to platoon, as well as identifying sections of road suitable for safe platooning;
5) an intelligent ordering of the vehicles based on several criteria;
6) other fuel economy optimizations made possible by the close following;
7) control algorithms to ensure smooth, comfortable, precise maintenance of the following distance appropriate for the operating environment and the vehicles in the platoon;
8) robust failsafe mechanical hardware onboard the vehicles;
9) robust electronics and communication;
10) robust, diverse forms of communication among the vehicles in and around the platoon for the benefit of the driver and for ensuring regular, reliable communications with a network operations center (“NOC”) such as maintained by a fleet manager;
11) assistance in preventing other types of accidents unrelated to the close following mode;
12) identification of one or more vehicles with which a first vehicle is communicating;
13) use of one or more modalities for determining and/or confirming distance separating vehicles of interest;
14) integrating data received from one or more sensors on a local, or sensing, vehicle, for identifying a second, or sensed, vehicle;
15) developing alternative approaches for determining vehicle location, including relative location among two or more vehicles.

Platooning systems are described in more detail in U.S. Patent documents U.S. Pat. Nos. 8,744,666, 9,582,006, 9,665,102, 9,645,579, and 10,074,894, each of which is incorporated by reference herein in its entirety. Additional aspects of platooning are described in co-pending U.S. patent application Ser. Nos. 15/590,803, 15/590,715, 15/605,456, 15/607,902, 15/926,809, 15,908,677, and 15/860,024, each of which are hereby incorporated by reference. Additional aspects of platooning are described in PCT Applications PCT/US2012/045830, PCT/US2014/030770, PCT/US2016/049143, PCT/US2016/060167, PCT/US2017/035019, PCT/US2017/046866, PCT/US2017/047771, PCT/US2017/047825, PCT/US2017/058477, PCT/US2018/020315, PCT/US2018/023723 each of which are hereby incorporated by reference in the present Application.

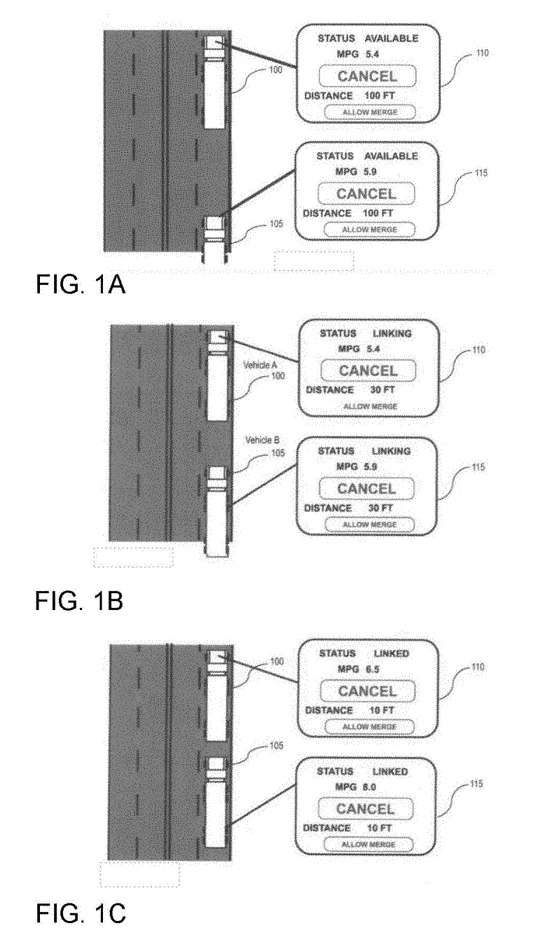

Referring first to FIGS. 1A-1C, three stages of platooning can be appreciated. In FIG. 1A, vehicle A, indicated at 100, and vehicle B, indicated at 105, are operating independently of one another, but each is available for linking. In some embodiments, the displays shown at 110 and 115, for vehicles A and B, respectively, illustrate status, distance from a candidate partner vehicle, and fuel consumption, in some instances, although other data can also be displayed as will be better appreciated hereinafter. In FIG. 1B, vehicles A and B are sufficiently proximate to one another that linking, or a merge into a platoon, is allowed. Candidates for linking are typically selected at a network operations center (NOC), such as, for example, a fleet management center if the vehicles are large trucks. In such an embodiment, the NOC sends to each vehicle a message identifying suitable candidates for linking, together with information to facilitate both drivers reaching a target rendezvous point at the same time so that they can form a platoon.

Thus, referring again to FIG. 1B, vehicles A and B have at this point been guided to a rendezvous point on a section of roadway suitable for platooning. As discussed in U.S. Pat. No. 8,744,666, incorporated herein by reference, and also as discussed in greater detail hereinafter, when the two vehicles are sufficiently proximate, a communications link is established between them, and a processing system resident in the front, or lead, truck, begins communicating with a similar processing system in the back, or follow, truck. In an embodiment, the lead truck then issues commands to the processing system of the follow truck to control, for example, the acceleration and braking of the follow truck and bring it into position at a close following distance behind the lead truck. In an embodiment, the processor in the lead truck also controls the acceleration and braking of the lead truck to ensure that the follow truck can be guided safely into position behind the lead truck but at a close following distance, for example in the range of 10 feet to 60 feet.

Once the follow truck has been guided into platooning position, the control system on the following truck maintains a gap separating the following truck from the rear of the lead truck. Therefore, as the gap is maintained and the lead vehicle accelerates or brakes, the lead vehicle effectively maintains control of at least the acceleration and braking of the following truck. At this point, the vehicles are linked, as shown in FIG. 1C. However, in at least some embodiments, the driver of the rear vehicle remaining in control of steering, such that the rear vehicle is operated only in a semi-automated manner. In other embodiments, fully automated operation of the rear vehicle is implemented. It will be appreciated by those skilled in the art that semi-automated and automated are sometimes referred to as semi-autonomous and autonomous.

When the vehicles are in platoon formation, a short-range communication link such as DSRC is adequate for communicating messages between the processors of each truck, although other forms of wireless communication can be used, for example, cellular. However, even while in platoon formation, it is useful for the vehicles to maintain regular communication with the NOC. As will be discussed in greater detail hereinafter, a variety of data is sent from each truck to the NOC, including truck condition and performance, route changes, local weather, and other data. This permits the fleet operator to proactively manage truck maintenance and repair, adjust routing for weather problems or road construction, identify vehicle location in the event of an emergency, and manage a variety of other analytics.

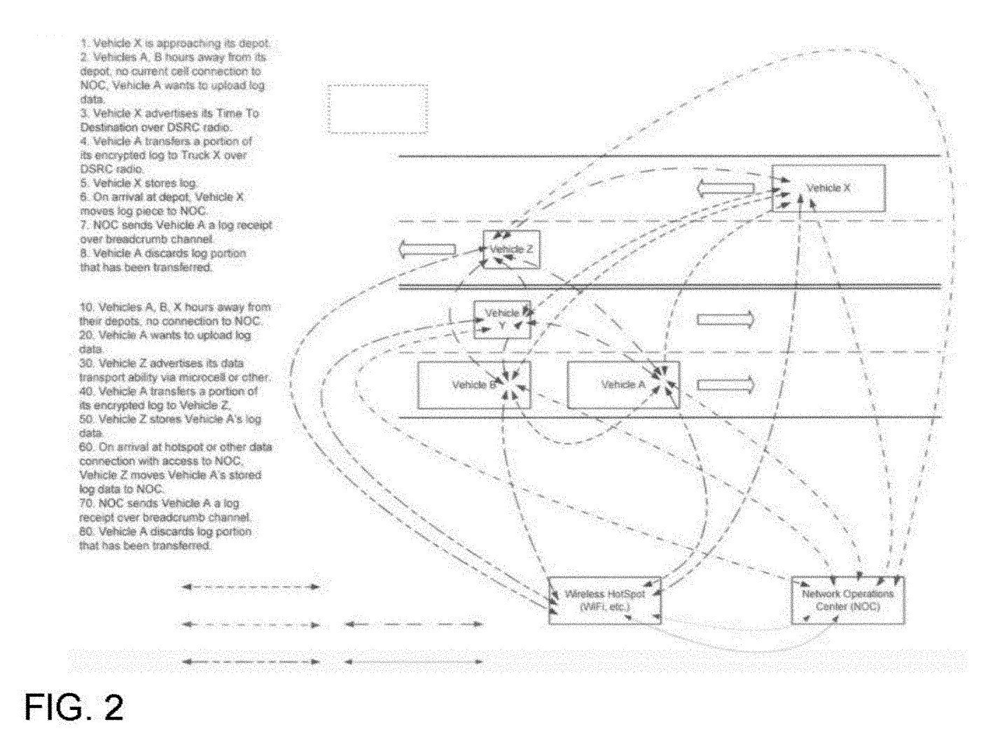

FIG. 2 illustrates an embodiment of communications links for managing messaging in a system according to the invention. More specifically, FIG. 2 illustrates an embodiment using a variety of communications protocols for managing messaging among potential or actual platoon partners, one or more associated NOCs, a wireless access point which provides remote access to the NOCs. Further, in instances where communication with the NOC is unavailable for a period of time, FIG. 2 illustrates an embodiment of a mesh network by which messages can be communicated between the NOC and a vehicle through intermediary vehicles. More particularly, vehicle 100 is in communication with platoon partner vehicle 105 via DSRC or other suitable wired or wireless technologies, as illustrated at 300. In addition, for most of vehicle 100's route, it is also in communication with NOC 310 via a cellular link 320. Similarly, vehicle 105 communicates with NOC 310 via a cellular link 320, absent a break in the wireless link.

However, cellular communication is not always possible, especially in vehicles driving long distances through varied terrain. Further, cellular is relatively slow for transfer of large amounts of data, such as may be stored on the vehicle if video recording or other high bandwidth functions are used. Thus, in some embodiments vehicles 100 and 105 are also equipped to access WiFi hotspots 330, which in turn communicate with the NOC through either a wireless link illustrated at 340, or wired channel illustrated at 350. Fixed WiFi hotspots are increasingly ubiquitous along the roadway, as well as at fleet operations centers. In addition, WiFi hotspots in vehicles based on 4G LTE or similar services have been introduced. Microcell and similar technologies can also provide a communications link in some instances.

In some embodiments a relay technique based on an ad hoc mesh network can be used. For example, suppose vehicle 100 is traveling east, and just passed through an area of good cellular connectivity to the NOC 300 but is now passing through a zone that has no wireless connectivity. Suppose, too, that vehicle X, shown at 360 is traveling west, and has been out of contact with the NOC for some period of time, but will regain wireless connectivity sooner than truck 100. In at least some embodiments, the NOC 310 knows with reasonable precision the location of each of the vehicles that it monitors based on travel forecasts, discussed in greater detail hereinafter, even when cellular or similar links are unavailable. Thus, if NOC 310 needs to send information to vehicle X, the NOC sends to vehicle 100 the message for vehicle X while vehicle 100 still has connectivity to the NOC. Then, when vehicle 100 and vehicle X are proximate, vehicle 100 relays the NOC's message to vehicle X. Similarly, if vehicle 100 needs to get data to the NOC, but is presently out of touch with the NOC, it can relay its data to vehicle X, and vehicle X retransmits the data to the NOC when vehicle X regains connectivity to the NOC.

It will be appreciated by those skilled in the art that, in some embodiments although possibly not in others, such wireless messaging will be encrypted for security purposes. With appropriate safeguards, vehicles not within the management of the fleet operation can also be used to relay messages. For example vehicles Y and Z, shown at 370 and 380, can receive messages from Vehicles A and B via link 390 and then relay them to NOC 310 if properly equipped for communication with the NOC, which can be by means of a standard protocol. In an environment having a sufficient quantity of vehicles equipped for wireless connectivity, a mesh network is created by which messages can be passed from vehicle to vehicle and thence to the NOC. Such a mesh network also permits the passing of status messages from vehicle to vehicle, so that, for example, the platoon of vehicles 100 and 105 is aware of the status of surrounding vehicles. For example, the platoon may be informed of where the car on the left needs to exit the roadway, which, for example, permits the platoon to avoid having that car cut in between vehicles 100 and 105 or otherwise behave in an unexpected manner. Likewise, emergency conditions can be communicated to the platoon, comprised of Vehicles A and B, well in advance, permitting increased operational safety.

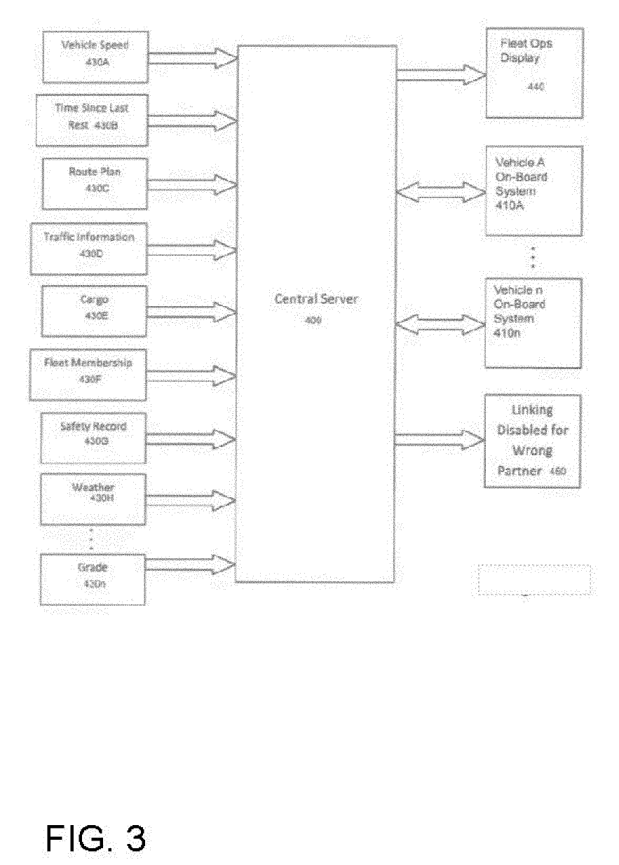

With the foregoing understanding of platooning and communications across the network and from vehicle to vehicle, the operation of the central server that, in at least some embodiments, directs and monitors the vehicles 100, 105, etc., can be better appreciated. With reference next to FIG. 3, the central server and some of its inputs can be seen in simplified block diagram form. The central server 400, either alone or in combination with the system onboard each vehicle 410, 420, makes decisions and suggestions either for platooning or simply for improved operation, based on knowledge of one or more of vehicle location, destination, load, weather, traffic conditions, vehicle type, trailer type, recent history of linking, fuel price, driver history, and other factors, all as shown at 430A-430n. The central server and the onboard systems both communicate with the driver through display 440. Those communications can involve linking suggestions, road conditions, weather issues, updated routing information, traffic conditions, potential vehicle maintenance issues, and a host of other data. In some instances, a linking opportunity may present itself independently of the central server. In such an instance, once the pairing is identified that potential pairing is communicated to at least the onboard system and, in most instances although not necessarily all, also communicated to the central server. It is possible that either the central server or the on-board systems will conclude that the pair is not suitable for linking, and linking is disabled as shown at 450.

As discussed in PCT application PCT/US14/30770, filed Mar. 17, 2014, linking opportunities can be determined while the vehicles are moving, but can also be determine while one or more of the vehicles is stationary, such as at a truck stop, rest stop, weigh station, warehouse, depot, etc. They can also be calculated ahead of time by the fleet manager or other associated personnel. They may be scheduled at time of departure, or hours or days ahead of time, or may be found ad-hoc while on the road, with or without the assistance of the coordination functionality of the system.

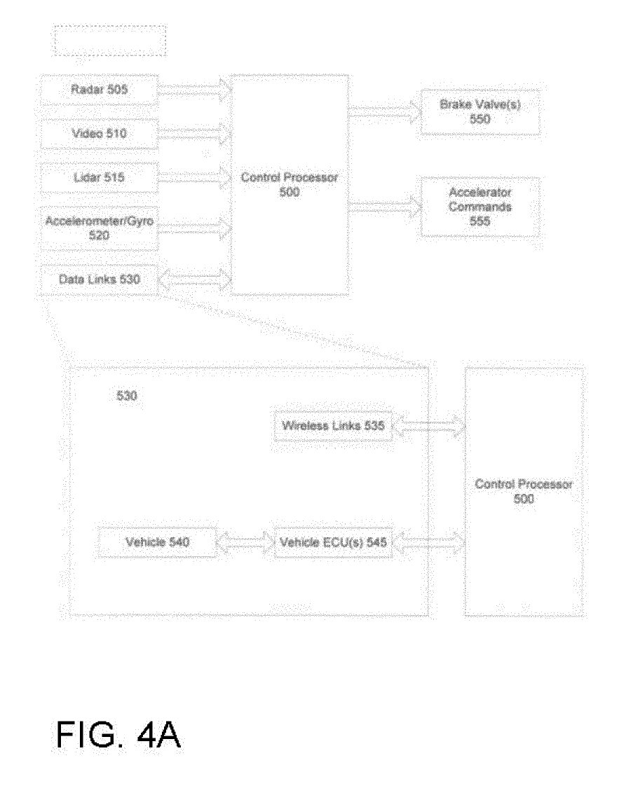

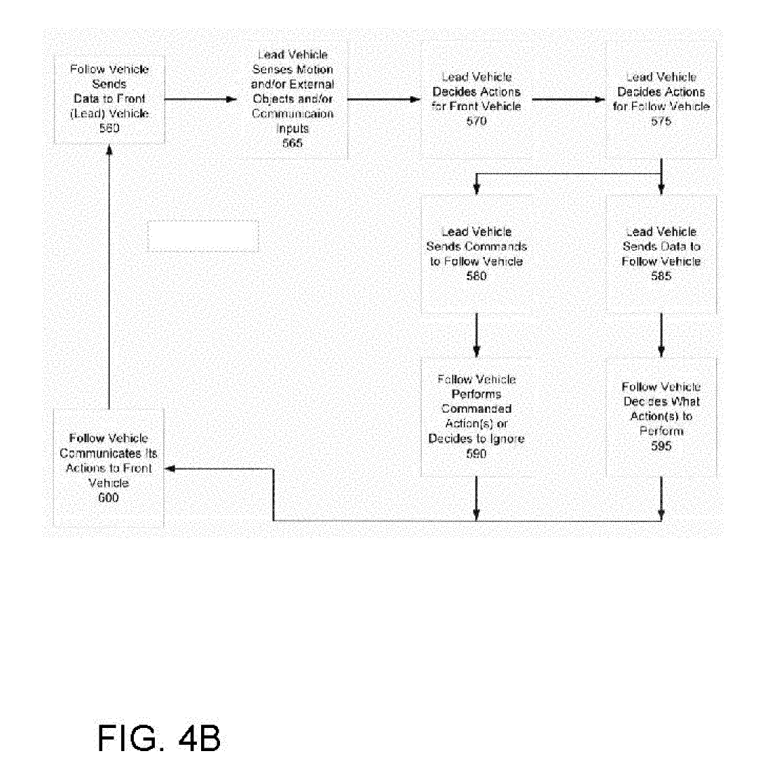

As noted above, much of the intelligence of the overall system can reside in either the central server, or in the system onboard each vehicle. However, the onboard system includes specific functions for controlling the operation of the vehicle. For example, for large trucks as well as for most vehicles, the onboard system receives a variety of inputs reflecting immediate operating conditions and, based on those plus relevant information received from the central server, controls the vehicle in terms of at least acceleration/velocity, and braking. Thus, as shown in FIG. 4A, an embodiment of an onboard system comprises a control processor 500 that receives inputs from, for example, an onboard radar unit 505, a video camera 510, and a lidar unit 515 via connection (a), typically but not necessarily a CAN interface. The control processor can configure each of these units and receive data. Connection (b) to inertial measurement sensors or gyros 520, which can be wireless, gives the control processor acceleration information in 1, 2 or 3 axes as well as rotation rate information about 1, 2 or 3 axes. In some embodiments, accelerometers can be substituted for gyros, although gyros are generally used for, for example, rotation rate. A plurality of data links 530, shown at (c) and expanded to show detail at the lower portion of FIG. 4A, provides information about relevant characteristics of the leading truck 100, including its acceleration, or is used to provide the same or similar information to the following truck 105. The brake valve and sensor 550, connected on bus (d), provides data on brake pressure, and is used to apply pressure via a command from the control processor 500. The accelerator command 555 is sent via an analog voltage or a communications signal (CAN or otherwise).

The control processor performs calculations to process the sensor information, information from the GUI, and any other data sources, and determine the correct set of actuator commands to attain the current goal (example: maintaining a constant following distance to the preceding vehicle). As shown there, the data links include one or more wireless links 535 such as cellular, DSRC, etc. The data links 530 also comprise inputs from the vehicle, shown at 540, which are typically transmitted via the vehicle's engine control unit, or ECU, indicated at 545 and typically provided by the vehicle manufacturer. Depending upon the embodiment, the control processor communicates bi-directionally with the various input devices.

The operation of the onboard system, or vehicle control unit, of the present invention can be better appreciated from FIG. 4B, which shows, for an embodiment, the general flow between the vehicle control units of two linked vehicles. Depending upon the embodiment, two modes of operation are typically implemented: in a first mode, the front truck's control unit issues commands to the back truck's control unit, and those commands are, in general, followed, but can be ignored in appropriate circumstances, such as safety. In a second mode, the front truck's control unit sends data to the second truck, advising the trailing truck of the data sensed by the lead truck and the actions being taken by the lead truck. The second truck's control unit then operates on that data from the front truck to take appropriate action. As shown at 560, the following or trailing truck sends data about its operation to the front or lead truck. At 565, the lead truck receives the data from the trailing truck, and senses motion and/or external objects and/or communication inputs. The lead truck then decides upon actions for the lead truck, shown at 570, and, if operating in the first mode, also decides upon actions for the back truck, shown at 575. Then, depending upon whether operating in first or second mode, the lead truck either sends commands (580) to the trailing truck (first mode), or sends data (585) to the trailing truck (second mode). If operating in the first mode, the second truck receives the commands and performs them at 590, with the caveat that the second truck can also chose to ignore such commands in some embodiments. If operating in the second mode, the second truck receives the data at 595, and decides what actions to perform. Because the control programs for both units are, in some embodiments, the same, in most cases the resulting control of the second truck will be identical regardless of operating mode. Finally, the second truck communicates to the front truck what actions it has taken, shown at 600, so that each truck knows the state of the other. It will be appreciated by those skilled in the art that the control programs need not be the same for both vehicles in every embodiment.

In at least some embodiments, the above process is repeated substantially continually, for example, once per second, to ensure that each truck has the current state of the other truck, and the NOC has current status for both, thus assisting in ensuring safe and predictable operation of each truck even when operating in close-order formation at highway speeds.

In addition to the foregoing inputs to the control processor of the onboard system, in some embodiments various warnings and alerts can be implemented as inputs to either the control processor or a separate warnings and alerts processor, as described in greater detail in the previously mentioned patent documents. Likewise, and also as described in the above mentioned patent documents, a brake check process can be implemented both to ensure that the vehicle brakes are working correctly and to help determine which vehicle should lead, as the vehicle with the better brakes will usually be positioned as the follow vehicle, all other parameters being equal.

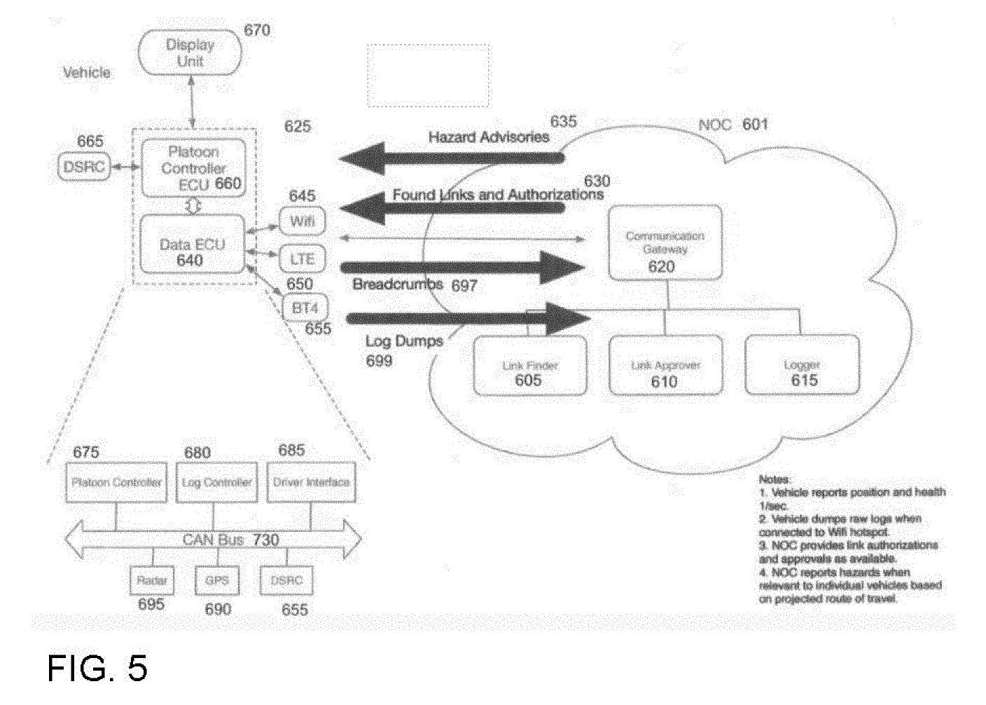

In at least some embodiments, reliably safe platooning involves a collaboration between the NOC and the onboard system. Thus, referring to FIG. 5, the interaction between the functionalities provided by the NOC and the operation of the onboard system can be appreciated at a high level. For purposes of establishing a platoon, the NOC 601, which resides in the cloud in at least some embodiments, comprises, in simplified terms, a link finder function 605, a link approver function 610, and a logger function 615. The outputs of the functions are conveyed through a communication gateway 620 to the onboard system 625. The onboard system 625 receives from the NOC 601 information about vehicle pairings that the NOC has determined to have linking potential, followed by linking authorizations at the appropriate time, indicated at 630. In addition, the onboard system receives hazard advisories, indicated at 635, which in general comprise hazards to the vehicle based upon the projected route of travel.

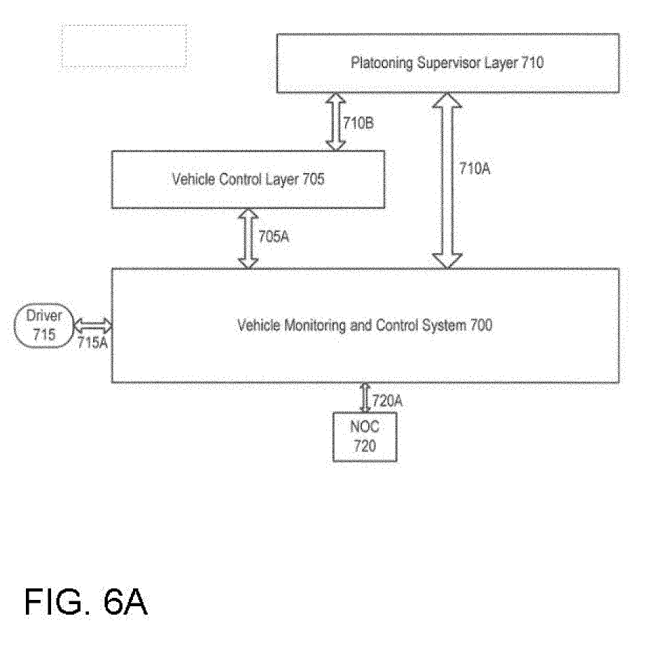

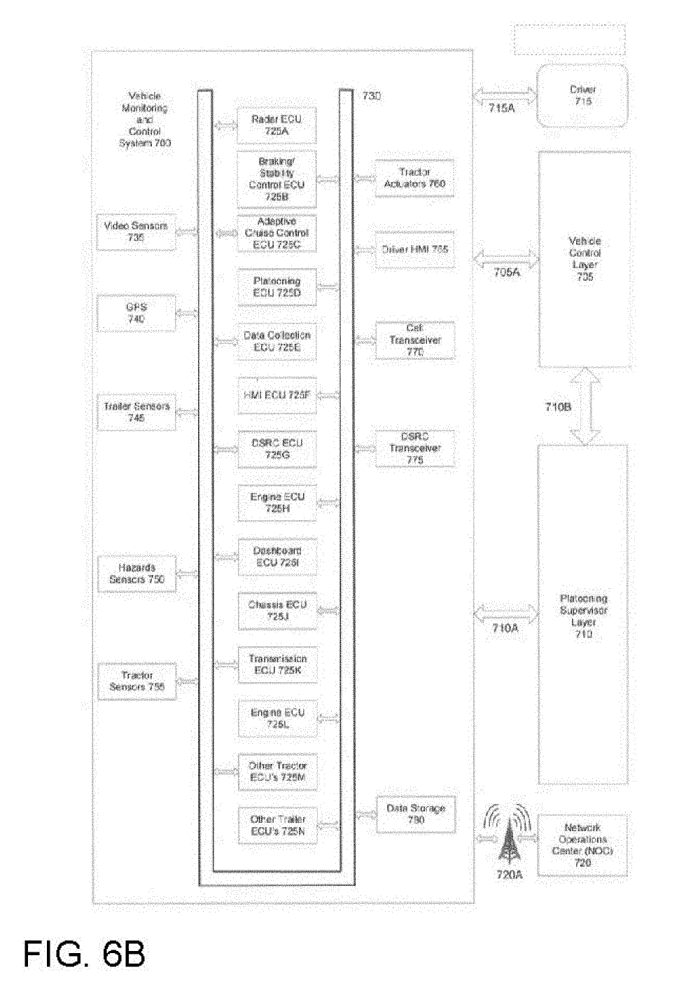

The onboard system 625 comprises, from a functional standpoint, one or more electronic control units, or ECUs, which manage various functions as more specifically described in connection with FIG. 6A. For the sake of simplicity of explanation, in FIG. 5 only a data ECU is shown, and it provides for message handling and communications management. It will be appreciated by those skilled in the art that the ECU function can be implemented in a separate device, or can be integrated into an ECU that also provides other functions. It will be appreciated that, in most instances, an ECU as described herein comprises a controller or other processor, together with appropriate storage and other ancillaries to execute program instructions of the type discussed in greater detail as discussed herein and particularly beginning with FIG. 6A. In an embodiment, the data ECU 640 manages the WiFi, LTE and Bluetooth interfaces, indicated at 645, 650 and 655, respectively, and in turn communicates bidirectionally with a platoon controller ECU function 660. The platoon controller ECU function in turn communicates bidirectionally with other platoon candidates and members via a DSRC link 665, and also outputs data to the driver's display 670.

In at least some embodiments, the onboard ECU function communicates with the vehicle's CAN bus 730 which provides connection to a platoon controller 675, log controller 680, driver interface 685. The ECU also provides back to the NOC reports of vehicle position and health, or “breadcrumbs”, at a rate of approximately once per second, as indicated at 697. In addition, when a data link with suitable high bandwidth and low cost is available, such as WiFi, the ECU dumps its log to the NOC, as indicated at 699. Depending upon the embodiment, the log can comprise all data, including video information, or can comprise a subset of that data. For example, in an embodiment, the log dump can comprise some or all CAN bus data including SAE J1939 data, some or all radar, lidar and video data, some or all GPS data, some or all DSRC data, and some or all status data for both radio systems. It will be appreciated by those skilled in the art that not all such data is transmitted on the CAN bus, and instead may be communicated via an Ethernet connection, a point-to-point connection, or other suitable communications link.

Referring next to FIG. 6A, an embodiment of a system in accordance with the invention is shown in a simplified form of schematic block diagram showing a hardware layer and the software layers that cause the hardware layer to perform the inventive functions. In particular, Vehicle Monitoring and Control System 700 comprises one or more processors and related hardware as further described in connection with FIG. 6B et seq. The System 700 provides data to and executes instructions from Vehicle Control Layer 705 via channel 705A and also provides data to and executes instructions from Platooning Supervisor Layer 710 via channel 710A. In addition, Platooning Supervisor Layer 710 also communicates with the Vehicle Control Layer 705 via channel 710B. It will be appreciated by those skilled in the art that layers 705 and 710 are software layers, executing on the hardware of the hardware layer shown as System 700.

The hardware components that comprise the Vehicle Monitoring and Control System 700, and their interoperation with software layers 705 and 710, can be better appreciated from FIG. 6B. More specifically, in an embodiment, the Vehicle Monitoring and Control System comprises one or more Electronic Control Units (ECUs) that receive inputs from various sensors and provide outputs to various actuators and other devices comprising, for example, the driver HMI and cell and DSRC transceivers, under the control of the Vehicle Control Layer 705 and Platooning Supervisor Layer 710. The System 700 also communicates with the Driver 715 over a connection 715A. The System 700 also communicates with a NOC 720, usually over a wireless link such as shown by cell tower 720A.

While a single ECU can perform all of the functions necessary in at least some embodiments of the invention, most modern vehicles have a plurality of ECUs, with each being assigned a specialty. Thus, as shown in the embodiment illustrated in FIG. 6B, a plurality of ECUs 725A-725N comprise the core of the System 700 and communicate with one another on bus 730 which can be, in at least some embodiments, a CAN bus although, depending upon the particular device being linked, the bus 730 can be a different type of bus or even a point-to-point connection. In an embodiment, the ECUs 725A-725N, which are merely representative and are not intended to represent an exhaustive list, receive inputs from video sensors 735, GPS device(s) 740, trailer sensors 745, hazard sensors 750, and tractor sensors 755. Depending upon the embodiment, fewer, more or different sensors can be used. The bus 730 also permits the ECUs to transmit control signals to tractor actuators 760, to provide data to and receive inputs from the driver via HMI 765, and to manage Cell and DSRC transceivers 770 and 775, respectively. Further, the bus 730 provides a link by which data from the various sensors and ECUs can be stored on Data Storage 780. The various ECUs 725A-725N can comprise, among others. Radar ECU 725A, Braking/Stability ECU 725B, Adaptive Cruise Control ECU 725C, Platooning ECU 725D, Data Collection ECU 725E, HMI ECU 725F, DSRC ECU 725G, Engine ECU 725H, Dashboard ECU 725I, Chassis ECU 725J, transmission ECU 725K. Other tractor ECUs can also be implemented, as shown at 725M, and other trailer ECUs can similarly be implemented as shown at 725N. It will be appreciated by those skilled in the art that the software comprising the vehicle control layer and the platooning supervisor layer can be distributed across one, some, or all such ECUs.

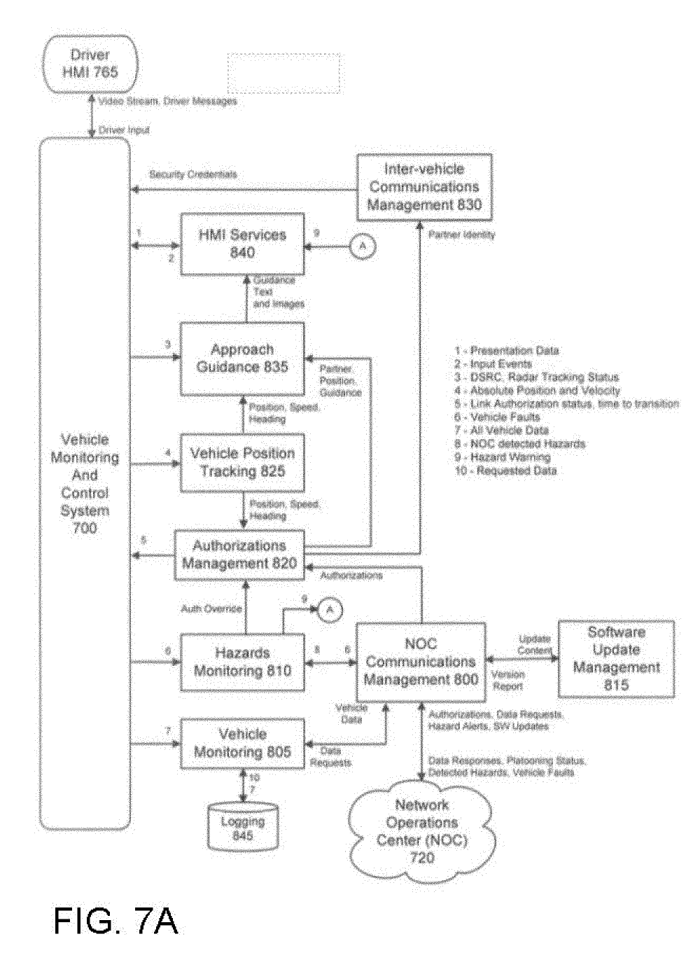

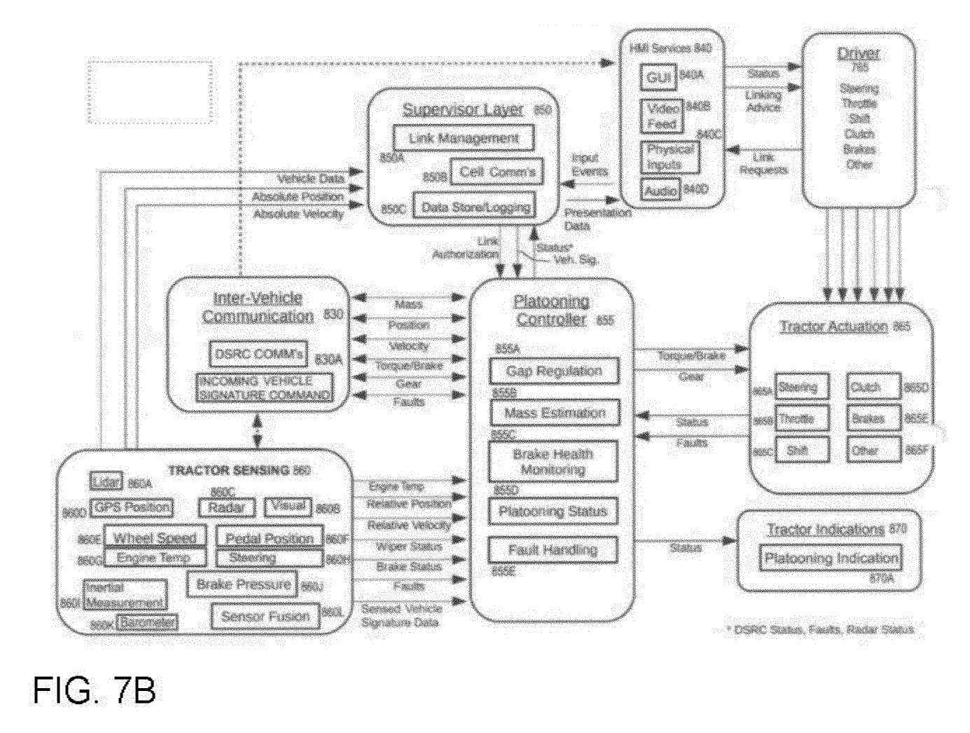

Referring next to FIG. 7A, the Platooning Supervisor Layer and its interaction with the Vehicle Monitoring and Control System 700 can be appreciated in greater detail. Except for the System 700, FIG. 7A illustrates various software functionalities of an embodiment of the present invention. The Driver HMI functionality, indicated at 765, interacts directly with the vehicle driver, and presents to the driver information from the System 700 as well as the Platooning Supervisor Layer as well as serving as the input mechanism for the Driver's commands and choices, for example, selections of a linking partner, or acceptance by the driver of an offered link.

The NOC Communications Manager 800 establishes and maintains a secure communication link between the vehicle and the NOC, and provides the mechanism for passing messages reliably to and from the NOC. The NOC Communications Manager receives inputs from the Vehicle Monitoring function 805, the Hazards Monitoring function 810, the Software Update Management function 815, and the NOC itself.

The Vehicle Monitoring functionality 805 samples and filters the vehicle state from any of the sources connected to the bus 730, based on requests from the NOC 720. The NOC 720 specifies what information is to be provided, and at what interval, or frequency, and also specifies how the data is to be processed before being communicated back to the NOC. Alternatively, local processing can replace the NOC. The Hazards Monitor 810 “listens” on the Bus 730 for vehicle faults and communicates relevant vehicle faults to the NOC. The Hazards Monitor 810 also receives hazard alerts from the NOC, and, based on its inputs including vehicle status and environmental conditions, makes a local determination on whether to override a platooning authorization. The Hazards Monitor provides an Authorization Override to Authorization Management function 820, and also sends a hazards warning to the driver via HMI Services function 840. The Software Update Manager 815 responds to version queries and provides the mechanism by which software on the vehicle can be remotely upgraded.

The Hazards Monitor can locally override a linking authorization from the NOC in the event a condition is detected which either negates a planned linking, adjusts the platooning distance, or otherwise alters the conditions on which the authorization is based. Such conditions typically include vehicle status problems, or adverse environmental conditions. If the Hazards Monitor override is based upon a vehicle fault or other status issue, that fault or issue is also communicated to the NOC so that the NOC can take it into consideration when evaluating future linking involving the vehicle. Other conditions leading to a Hazards override can result from issues external to the vehicle itself, such as weather, traffic or road conditions detected by other vehicles. Depending upon the embodiment and the particular condition, the information about the external issue can be communicated to the NOC by another vehicle, and then sent to the vehicle receiving the linking authorization, or the information about the external issue can be communicated from the other vehicle directly to the vehicle receiving the linking authorization. In either case, the onboard system passes the hazard information to the Hazards Monitor, which takes appropriate action to either cancel or modify the authorized linking.

In the absence of an override from the Hazards Monitor, the Authorizations Manager 820 receives and interprets authorization packets from the NOC, via the NOC Communications Manager 800, in combination with absolute position, speed and heading information from the Vehicle Position Tracking function 825 [in turn received from the System 700] to help determine the proximity of the platooning partners proposed by the NOC, as discussed in greater detail hereinafter. The Authorizations Manager sends to the System 700 a link authorization status message together with a time to transition, i.e., a time at which the platooning partner is proximate and linking can begin. The Authorizations Manager also sends an identification of the selected platooning partner to Inter-vehicle Communications Management function 830, and, in some embodiments, sends to an Approach Guidance function 835 information regarding the selected platooning partner, its position, and guidance for linking.

The Inter-vehicle Communications Manager 830 manages the mutual authentication of the platooning partners by providing security credentials to the System 700, typically communicated over a DSRC link. In embodiments having approach guidance, the Approach Guidance function 835 operates in two modes. When the partner vehicle is outside DSRC range, it provides approach guidance directly from the NOC, if such guidance is available. Then, once a secure communications link with the platooning partner has been established, over a DSRC link in at least some embodiments, the Approach Guidance function provides local approach guidance independent of the NOC, using position and speed information provided by the partner vehicle together with local vehicle tracking information, such as radar tracking status received from System 700 and data from Vehicle Position Tracking function 825. Depending upon the embodiment, the guidance can comprise supplying the driver with none, some, or all of mapping, video and radar inputs, lane alignment, and any other data available from the system. In some embodiments, the driver manually uses such data to position the vehicle for platooning, at which point the platooning controller engages and brings the vehicles to the desired platooning gap.

The HMI Services function 840 provides the semantic layer for interaction with the driver of the vehicle, and converts status information from the vehicle, including the software layers, into relevant messages to the driver. In addition, the HMI Services function processes inputs from the driver. The HMI Services module provides presentation data to the Vehicle Hardware for display to the driver on the Driver HMI, typically a touchscreen display to permit easy entry of driver commands, choices, and other inputs. For the driver of the following vehicle, the display typically includes a video stream of the forward-looking camera on the lead vehicle.

Referring next to FIG. 7B, the software functionalities described above can be appreciated in the context of the software functions of the system as a whole. As in FIG. 7A, the Inter-vehicle Communications function 830, which includes management of DSRC Communications and Incoming Vehicle Signature Commands, sends messages to HMI Services function 840, which provides an interface to the Driver function shown at 765. Inputs from the driver interface 765 include link requests based on the driver's selection of a platoon partner. It will be appreciated that multiple potential platoon partners will exist on many routes, thus giving the driver multiple options. However, in some embodiments and for some fleets, the platoon partner choices will be determined at fleet operations, for example where multiple trucks routinely follow the same route to the same or nearby destinations. In such instances the driver's options are either to accept the link or to reject it.

The HMI Services function also provides to a Supervisor Layer 850 input events received from the driver, and receives from the Supervisor Layer presentation data. The HMI Services function comprises, in an embodiment, a GUI 840A, video feed 840B, physical inputs 840C, and audio inputs and outputs 840D. The Supervisor Layer includes a Link Management function 850A, cellular communications management 850B and data store and logging 850C.

The Supervisor Layer also sends Link Authorizations and Vehicle Signature commands and data to a Platooning Controller function 855, and receives from that controller status messages including DSRC status, faults, and radar status. The Platooning Controller 855 comprises various functions, including Gap Regulation 855A, Mass Estimation 855B, Brake Health Monitoring 855C, Platooning Status 855D, and Fault Handling 855E, Gap regulation can involve setting a distance from the lead to the follow vehicle, or can involve setting a time headway from the back of the lead vehicle to the front of the follow vehicle. In either event, the objective is to ensure that the distance provides acceptable fuel economy benefits while at the same time ensuring the safety of both vehicles.

To perform the foregoing functions, the Platooning Controller receives inputs from the tractor representing status of various tractor functions, shown generally at Tractor Sensing 860. In an embodiment, those functions include lidar data 860A, visual data 860B, radar 860C, GPS position 860D, wheel speed 860E, pedal position 860F, Engine Temperature 860G (sensed either from the block, from the engine bay, or other suitable location), steering 860H, inertial measurement 8601, brake pressure 860J, barometer and related weather sensing 860K, and combinations of such sensed data indicated as sensor fusion 860L. Other data, such as fuel level or remaining driving range, as well as Sensed Vehicle Signature Data is also provided in some embodiments. In some embodiments, the Tractor Sensing function communicates bi-directionally with the Inter-Vehicle Communication module, in particular where some processing of the data related to vehicle signature occurs within the ECUs associated with the Tractor Sensing functions.

The Platooning Controller communications bi-directionally with the Inter-vehicle Communication module 830 regarding mass, position, velocity, torque/braking, gear and faults. More specifically, the Controller 855 receives, via the DSRC link, data about the other vehicle including mass, position, velocity, torque/brake status, gear, and faults. The Platooning Controller uses these inputs to provide the status data to the Supervisor Layer, as mentioned above, and also provides torque and brake commands, and gear. In the absence of a gear sensor, gear selection can be calculated for manual transmissions based on engine speed and tire rotation speed. Gear on automatic transmissions can be sensed directly from the Transmission ECU.

The Platooning Controller 855 also receives status and fault information from a Tractor Actuation function 865, which, in an embodiment, comprises the functions 865A-865F of steering, throttle, shifting, clutch, and braking as well as other driver-controlled actions such as a Jake brake, etc. In at least some embodiments, the driver [function block 765] can provide all of such inputs to the tractor actuation block 865, although both braking and throttle are under the control of the platooning controller 855 during linking and while linked as a platoon. In some embodiments, a Tractor Indication function 870, comprising a Platooning Indication 870A, is also provided, and controls a physical indicator positioned on the tractor and visible to other vehicles proximate to the platoon. The physical indicator is typically enabled when a platoon is formed, and can also be enabled during the linking process.

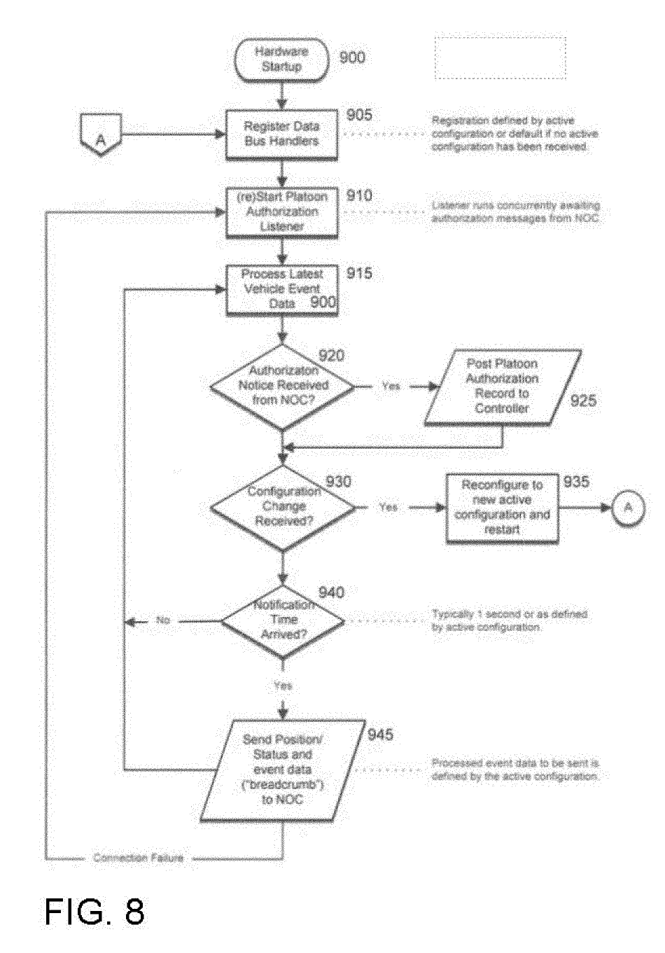

Turning next to FIG. 8, the data processing that occurs on the vehicle can be better appreciated. When the vehicle is started, the hardware starts up as shown at 900. The data bus handlers are registered with the system at 905, using either a default configuration or, if a configuration has been received from the NOC and is active, using that active configuration. At 910 a platoon authorization “listener” is started, whose function is to listen for platoon authorization messages from the NOC.

Next, at step 915 the latest vehicle event data is processed, after which a check is made at 920 to see whether a platoon authorization notice has been received from the NOC. If so, at 925 the authorization record is posted to the controller by a software interface such as an API. If no platoon authorization has been received, a check is made at step 930 to determine whether a configuration change has been received from the NOC. If so, the new configuration is implemented and alters what data is collected from the vehicle and reported to the NOC in a “breadcrumb” message, and a restart signal is sent to cause a loop back to step 905 where the data bus handlers are re-registered in accordance with the new configuration.

If no new configuration has been received, the process advances to step 940, where a check is made to see if sufficient time has elapsed that position and status information are due to be sent to the NOC. If not, the process loops back to step 915. If so, the position and status information, or “breadcrumb” message, is sent to the NOC. The frequency at which such breadcrumb messages are sent to the NOC is, in at least some embodiments, defined by the configuration parameters received from the NOC, which parameters also define the event data that is to be sent to the NOC as part of the message. In at least some embodiments, the “breadcrumb” message is reported to the NOC regularly, for example once per second. In addition, when appropriate, an “I am available for platooning” message is also sent regularly to the NOC.

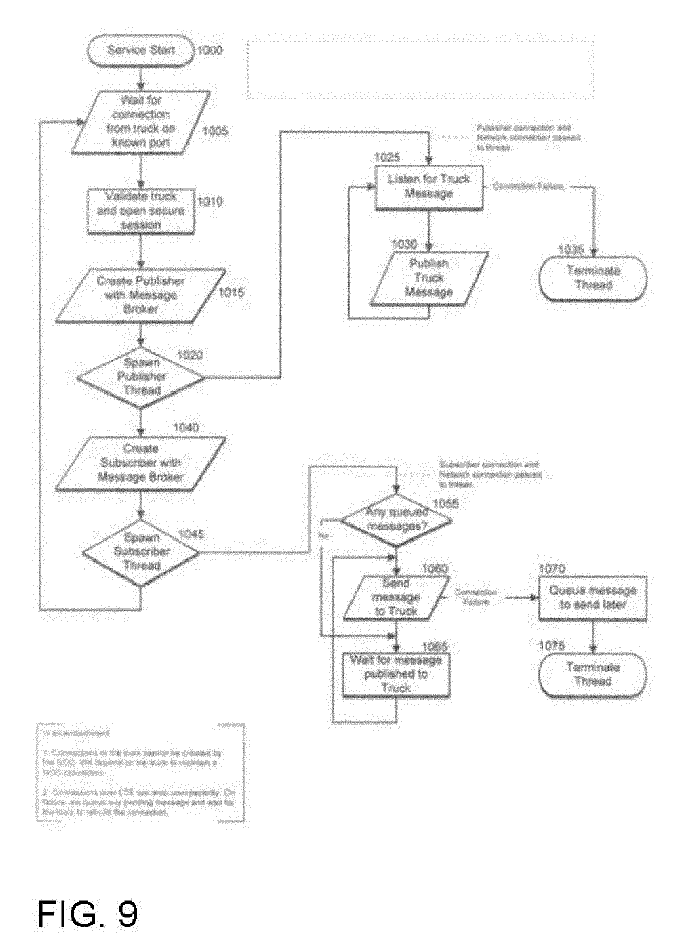

FIG. 9 illustrates an embodiment of the process by which connections between the NOC and the vehicle are managed. Service at the NOC starts as shown at step 1000, and the NOC waits for a connection from a vehicle on a known port, shown at 1005. The NOC then validates the truck and opens a secure session, shown at 1010, followed by creating a publisher message with a message broker functionality as shown at step 1015. A publisher thread is then spawned at 1020, at which point the publisher connection and the network connection are passed to the thread. The thread listens for a message from the vehicle, for example a “breadcrumb” message or an “I'm available for platooning” message, shown at step 1025. Once a message is received from the vehicle, shown at step 1030, the process loops and the NOC returns to listening mode at step 1025. If no message occurs within a given time window, the thread terminates as shown at step 1035.

Following the spawning of the publisher thread, and essentially in parallel with the execution of that thread, the process creates a subscriber message with a message broker as shown at 1040. A subscriber thread is then spawned at step 1045, and the subscriber connection and network connection are passed to the subscriber thread as shown at 1050. A check is made for queued messages at 1055, and any queued messages are sent to the vehicle at 1060. If there are no queued messages, or if the queued messages have been sent, the process advances to step 1065 and waits for the message to be published to the vehicle. The process then loops back to step 1060. In the event that the message could not be sent to the truck at step 1060, typically as the result of a connection failure, the messages are queued at step 1070 and the thread terminates at step 1075.

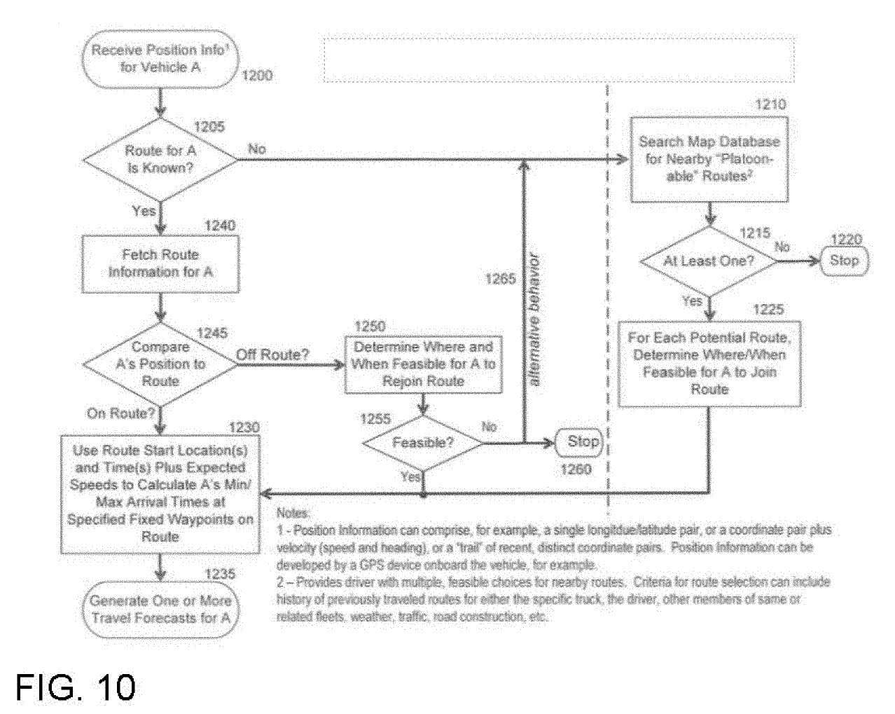

While platooning (or preparing to platoon), the route for a vehicle available for platooning must be known at least in part. This can be accomplished by generating a vehicle travel forecast, as shown in FIG. 10. The process there starts by receiving position information for a vehicle, designated Vehicle A, at step 1200. The position information can comprise longitude/latitude information, or comprise a coordinate pair plus speed and heading, or comprise a series or trail of coordinate pairs. A GNSS or GPS device can be suitable providing such information.

The process of FIG. 10 continues by checking at step 1205 to determine whether Vehicle A's route is known. In many instances, vehicles such as large commercial trucks travel routes that are repeated frequently, or are set by a fleet manager or other supervisor. As a result, in many instances a particular vehicle's route is known and stored in a database, typically maintained at a NOC and, in at least some instances, also available locally. If, however, Vehicle A's route is not known, a search is made at step 1210 for nearby routes that would be acceptable for platooning.

After the search at step 1210, a check is made at step 1215 to determine if at least one platoonable route, suitable for use by Vehicle A, is found. If not, the process stops for the time being, as shown at step 1220. However, in most instances at least one platoonable route will be identified. In such cases, a determination is then made as to where and when it is feasible for Vehicle A to join the platoonable route, as shown at step 1225. Then, at step 1230, Vehicle A's route start location and time is used together with Vehicle A's expected speeds, to calculate, in the NOC or in the Vehicle Monitoring and Control System 700, minimum and maximum times for Vehicle A's arrival at specific waypoints on the identified route. Based on those calculations, a travel forecast for Vehicle A is then generated in either a local or remote process, as shown at step 1235. The travel forecast, which is stored at the NOC in at least some embodiments, can then be used to search for potential platooning partners.

If Vehicle A's route is known, the route information is fetched from the database of known routes. Vehicle A's position is then compared to the known route, as shown at step 1245. If Vehicle A is off route, a determination is made at step 1250 as to where and when it is feasible for Vehicle A to rejoin the expected route. If rejoining is determined feasible, as shown at step 1255, the process loops back to step 1230 to provide Vehicle A with appropriate guidance for rejoining the route, followed by generation of a travel forecast. If it is not feasible for Vehicle A to rejoin the route, the process terminates, for the time being, at step 1260. A termination at either step 1220 or step 1260 is temporary, since platooning possibilities change as Vehicle A's position on its route changes and, in at least some embodiments, vehicles report their changed position via breadcrumb messages.

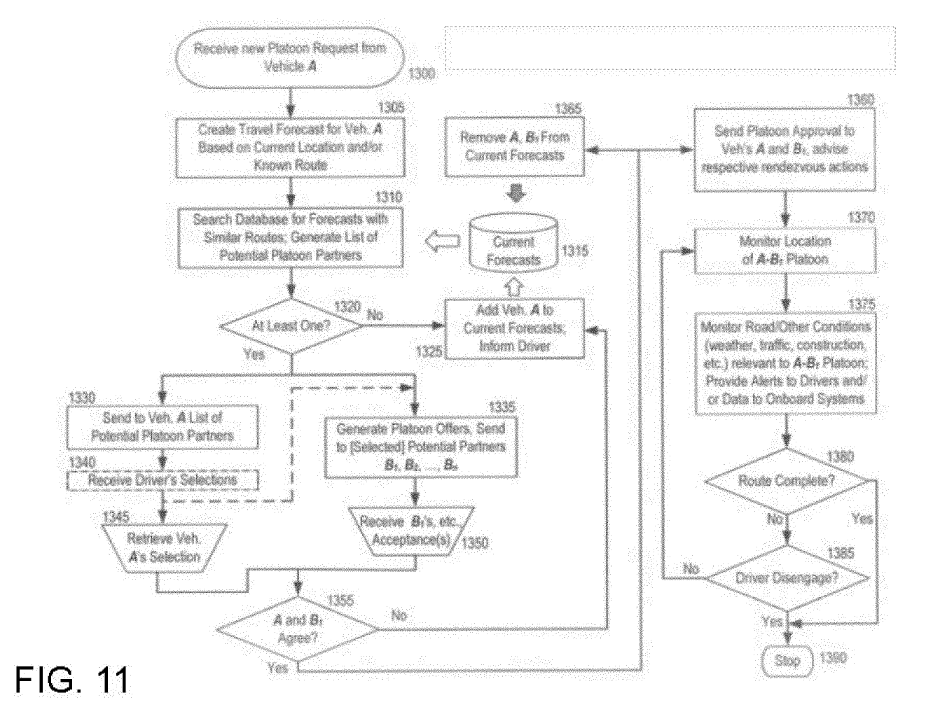

Once a travel forecast has been generated for Vehicle A, it is possible to search for potential platooning partners. One embodiment for such a search and linking process is shown in FIG. 11. The process of FIG. 11 begins with the receipt of a platoon request from Vehicle A. The request, shown at step 1300, is received at a processor, located in the NOC in at least some embodiments but potentially located elsewhere in other embodiments. A travel forecast such as results from the process of FIG. 10 is then either generated or retrieved, as shown at step 1305. At step 1310, a search of the travel forecasts stored in a database at the NOC, shown at 1315, is made to identify other stored forecasts with similar routing. Based on those similar routings, a list of potential platoon partners is generated in the processor.

Occasionally, no potential platoon partners will be identified by the search, in which case a check made at step 1320 produces a “No” result. In such an event, Vehicle A's travel forecast is added to the database 1315 if not already stored, and the driver is informed that no platooning possibilities currently exist. In most cases, however, one or more potential platooning partners will be identified, such that a “Yes” results from the check at step 1320. If so, a list of potential partners is sent to Vehicle A, as shown at step 1330. Depending upon the embodiment, a platoon offer can also be sent concurrently to the identified potential partners, B₁ . . . , Bₙ, as shown at step 1335. In some cases, and as shown at step 1340, the driver selects from the list provided in step 1330, and a platooning offer is sent only to those partners selected by the driver of Vehicle A. In some embodiments, the fleet operator determines the potential pairings and the driver receives only one choice, which can either be accepted or rejected. At step 1345, Vehicle A's selection is retrieved, typically indicated by a manual or audible command from the driver. The responses from the potential partners, for example Vehicle B₁, are shown at step 1350. A check for acceptance of the platooning offer is made at step 1355. Should there be no acceptances, Vehicle A's travel forecast is added, if not already stored, to the current travel forecasts database as shown at step 1325.

In most cases, Vehicles A and B₁ agree, in which case the process advances to step 1360. As shown at step 1360, in most cases platoon approval is sent by the NOC, as discussed above in connection with FIGS. 8A-8B, together with advice for the respective rendezvous actions to be taken by Vehicles A and B₁. In addition, as shown at step 1365, the travel forecasts for Vehicles A and B₁ are removed from the database of current travel forecasts, since neither is currently available for platooning. In some embodiments, platoons of more than two vehicles are permitted, in which case the travel forecasts of Vehicles A and B₁ are maintained in the database of current travel forecasts.

Following approval of the platoon, the positions of vehicles A and B₁ is monitored by the NOC, including during formation of the platoon and thereafter. In addition, the NOC monitors road and other conditions such as traffic, weather, construction, and so on, to identify conditions relevant to the platoon of Vehicles A and B₁ provides alerts to both drivers as well as providing relevant data or commands to the onboard systems for each vehicle. Such monitoring continues at least until the platoonable routing is completed, step 1380, or one of the drivers disengages, step 1385, after which the process stops at 1390.

While the benefits of platooning make it desirable to link vehicles whenever possible, not all sections of a roadway are appropriate for platooning. Thus, for long range coordination of vehicle for purposes of linking, an analysis of the roadway is required before such platooning can be authorized. Some sections of a roadway may be designated in the NOC's database as inappropriate for linking. Such geo-fencing can exist for numerous reasons, such as road construction, traffic, traffic control, and so on. It is therefore especially advantageous that all vehicles in a platoon know both their positions relative to the roadway and to any geo-fenced portions that may be designated, and also relative to each other.

In at least some embodiments, GPS position data is used at least to guide potential partner vehicles into close proximity, and in some embodiments, as discussed above, is used to provide relative position data; that is, the position of a first vehicle to a second vehicle such as the lead vehicle and the following vehicle in a platoon. In other embodiments, GPS data may also provide velocity data for each of the vehicles, and the relative velocity between platooning vehicles may also be determined.

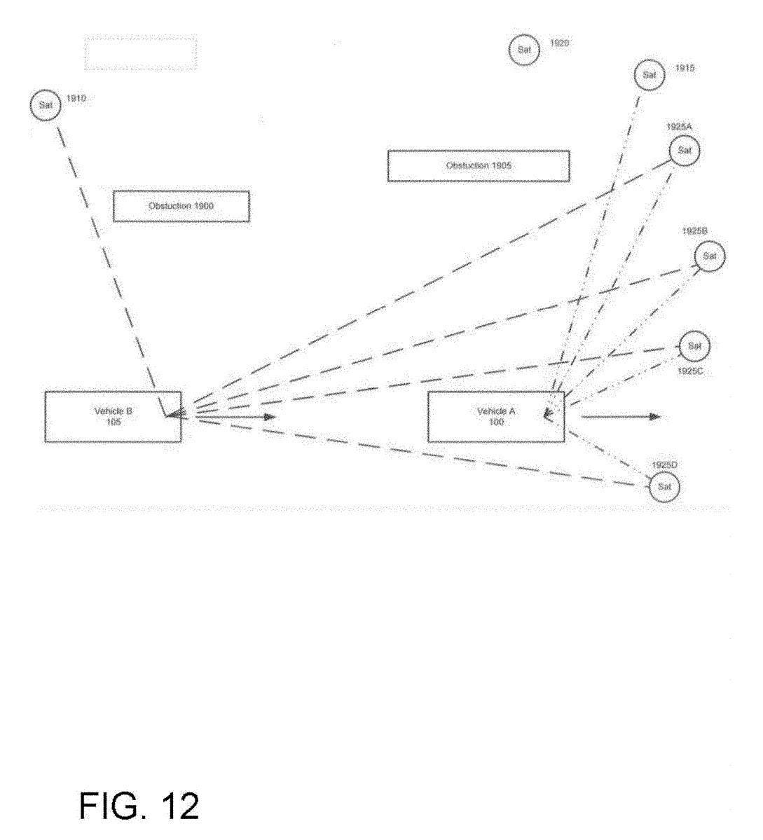

In many circumstances, the accuracy of relative GPS position data can be within a few centimeters, and thus provides valuable data for managing the gap between the vehicles. However, the accuracy of relative GPS position can vary depending upon the satellites visible to each vehicle. Thus, for example, FIG. 12 illustrates a real world scenario where Vehicle A, indicated at 100, and Vehicle B, indicated at 105, are traveling at different points along the same roadway and in the same direction as shown by the arrows.

Even if the distance between the vehicles is comparatively small, obstructions such as those shown at 1900 and 1905 can prevent the GPS receiver in each vehicle from seeing (also referred to as being able to receive data from and/or transmit data to) the same satellites that are seen by the other vehicle. Differences in the set of satellites used by the two vehicles can cause significant errors in sensed relative positioning between the vehicles. For example, obstruction 1900 can be a berm adjacent a portion of the roadway, sufficient to block vehicle A from seeing satellite 1910. Similarly, obstruction 1905 can be a large building adjacent a roadway, and prevent vehicle B from seeing satellite 1915 or prevent both vehicles A and B from seeing satellite 1920. However, both vehicles A and B can see satellites 1925A-1925D, which is typically adequate for obtaining reliable GPS relative position data.

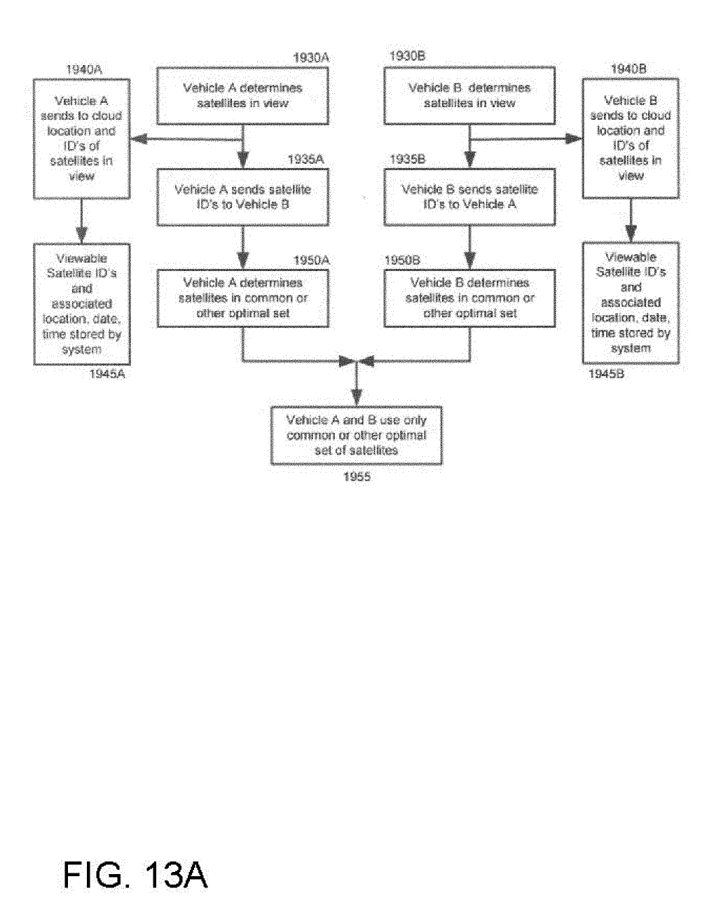

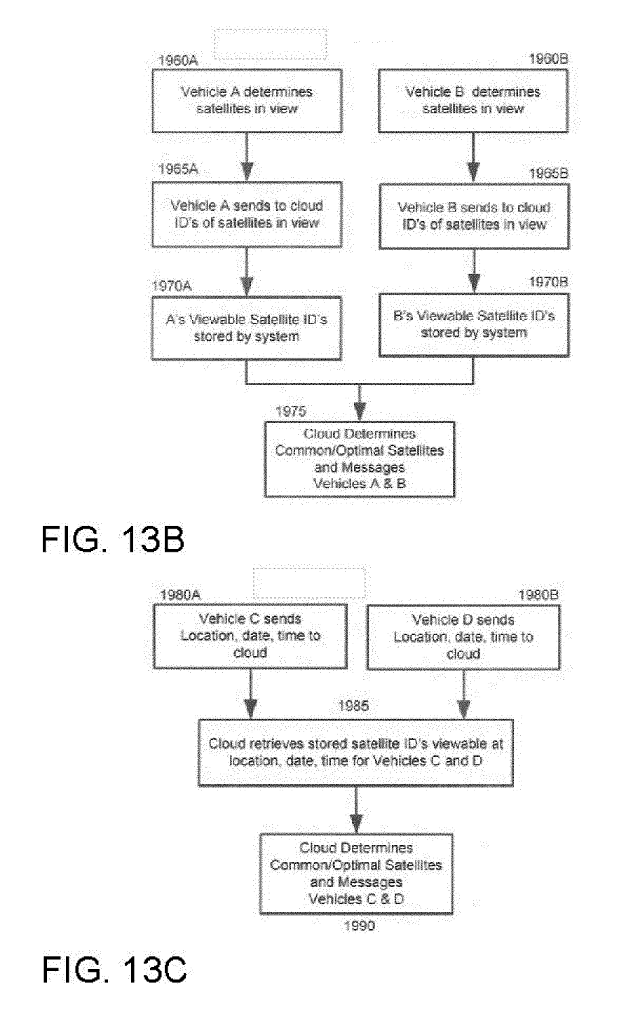

The potential difficulty comes from the fact that vehicle A can see satellite 1915, whereas vehicle B cannot; and vehicle B can see satellite 1900 whereas vehicle A cannot. To optimize accuracy, it is desirable in some instances and in some embodiments to have the GPS receivers in both vehicles relying on data from only the same satellites. In some embodiments, this is achieved by each vehicle using the common set of satellites. In other embodiments, the vehicles may choose to use, or be commanded to use, more than the common set of satellites, but choose an optimum set for each vehicle based on knowledge of the visible satellites to the other vehicle. This can be achieved through the process shown in FIG. 13A, or the alternative processes shown in FIGS. 13B and 13C.

The process of FIG. 13A begins with each vehicle's GPS receiver identifying the satellites it sees at that time, shown at steps 1930A, 1930B. Each vehicle then sends to the other the satellites that that vehicles sees, shown at 1935A-1935B, or, optionally, one vehicle sends the satellites it sees to the other but the second vehicle does not send that information to the first vehicle. In addition, and also optionally, data representing which satellites are viewable by each vehicle at that time is sent to the cloud/NOC for storage as shown at 1940A-1940B. In addition, in some embodiments location information for the vehicles is also sent to the cloud, although the transmission of position information can occur as part of the breadcrumbs message shown in FIG. 8 rather than being separately sent in the process of FIG. 13A. For those embodiments where the satellite data is sent to the cloud, the data is stored as shown at 1945A-1945B. The data can also include date and time information. Again, it will be appreciated that, as an alternative, one vehicle may transmit its satellite data to the other vehicle and leave the other vehicle to manage communication of that data to the NOC. Such load sharing permits better utilization of the communications links as well as permitting the non-responsible vehicle to perform other tasks.

Next, as shown in steps 1950A-1950B, one or both vehicles determine which ones are the commonly viewable satellites, or other optimal set of satellites, and limits their GPS receivers to relying upon only the pseudoranging data from either the commonly viewable satellites or other optimal set of satellites as shown at step 1955. It will be appreciated that the limitation can be imposed either in advance of processing, such that only certain inputs are considered, or it can be imposed after processing by not considering the data from satellites that are not commonly viewable or otherwise part of the optimal set. It will be appreciated by those skilled in the art that the process of FIG. 13A can take many forms, but, at bottom, the objective is that each vehicle determines which satellites it can view, and that information is then either shared or not, but at least one of Vehicle A, Vehicle B, or the cloud/NOC, knows which satellites are in view for each vehicle, and based on that knowledge the GPS receivers in each vehicle ultimately rely only on data derived from the satellite that are optimal to each vehicle, which may be those that are commonly viewable. It will be appreciated that the visibility of one or more satellites varies significantly with location, and thus the process of FIG. 13A is, in at least some embodiments, repeated regularly to ensure reliable relative position information for the vehicles traveling in close proximity.

Turning next to FIG. 13B, an embodiment in which the cloud determines which satellites should be relied upon by each vehicle can be better understood. As with FIG. 13B, vehicles A and B each determine which satellites they can each view, shown at 1960A-1960B. Again, each sends its satellite information to the cloud, steps 1965A-1965B, or, alternatively, one offloads its satellite data to the other and allows the other to manage communications with the cloud. In either approach, the satellite IDs viewable by each vehicle's GPS receiver are stored in the cloud, steps 1970A-1970B and including date and time in at least embodiments, where the NOC or other cloud-based system determines which satellites should be relied upon by each vehicle and messages both vehicles accordingly, step 1975. As with FIG. 13A, the NOC or other cloud service receives location information for each vehicle, such as shown in FIG. 8, in a manner that allows correlation with the satellite data.

The process of FIG. 13B permits vehicles C and D to rely on information maintained in the cloud regarding the satellite that are commonly viewable along a given route. Thus, at steps 1980A-1980B, vehicles C and D each provide their location, date and time information to the cloud in the routine manner. At step 1985, the cloud-based service or NOC retrieves from its database the stored data for which satellites are viewable at the locations of vehicles C and D at those dates and times. The cloud then determines the commonly viewable satellites and messages vehicles C and D accordingly. It will be appreciated by those skilled in the art that, while the locations of the satellites changes, their paths are precisely predictable and thus it is straightforward to compensate for the changes in satellite location that naturally occur. Those skilled in the art will also appreciate that, in most instances, the processes of FIGS. 13A-13C will occur when the vehicles are relatively proximate to one another, typically within DSRC range, although such proximity is not required in all instances or all embodiments.

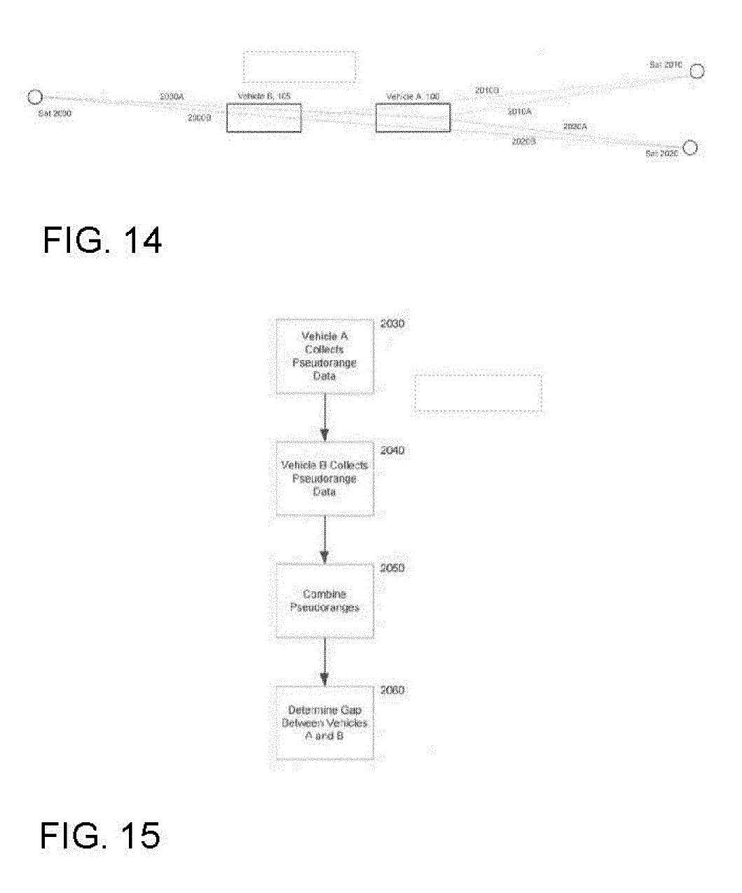

In some locations, it is difficult for GPS receivers to see the typical minimum of four satellites. For example, mountainous areas limit the number of visible satellites. At the same time, it can be desirable to calculate and receive relative GPS position data in those locations. In such challenging environments, an alternative approach can be to use pseudorange data from satellites that are substantially collinear with the vehicles velocity vector. Referring next to FIG. 14, for example, assume that vehicles A and B, indicated at 100 and 105, respectively, are traveling in close proximity along a mountainous roadway. Because mountains rise up on either side of the roadway, satellites positioned laterally to the vehicles are not visible. At the same time, Satellites 2000, 2010 and 2020 are visible, and they are substantially collinear with the roadway. Thus, vehicle A has line of sight 2000A to satellite 2000, line of sight 2010A to satellite 2010, and line of sight 2020A to satellite 2020. Vehicle B has similar lines of site as indicated on FIG. 14.

In such an arrangement, relative position data for vehicle A with respect to vehicle B can be determined by the process shown in FIG. 15. The process starts at steps 2030 and 2040 with each vehicle's GPS receivers collecting the available pseudorange data from satellites 2000, 2010 and 2020. Then, at step 2050, the pseudorange data is combined by either vehicle's control system or by a cloud-based server. Finally, at step 2060, the combined pseudorange data provides the gap distance between vehicles. The gap distance determined in this manner can, of course, serve as one modality of measuring gap, and used for validation of gap distance as measured by the vehicles' local sensors in the various manners discussed above.

In sum, the present invention provides devices, systems and methods for vehicle monitoring and platooning, including in some embodiments various capabilities for semi-automated vehicular convoying as well as systems, processes and methodologies for integrating sensor data with communicated data to yield improved identification of platoon partners as well as providing increased safety for vehicles traveling in close proximity and improved platoon performance. Among the many advantages of such a system are the ability to follow closely together in a safe, efficient, convenient manner, together with improved fuel economy, better fleet management, improved proactive fleet and vehicle maintenance, reduced accident risk, and numerous other benefits.

While this invention has been described in terms of several embodiments, there are alterations, modifications, permutations, and substitute equivalents, which fall within the scope of this invention. In view of the many alternative ways of implementing the methods and apparatuses of the present invention, it is intended that the following appended claims be interpreted as including all such alterations, modifications, permutations, and substitute equivalents as fall within the true scope of the present invention.

1. A method for determining position coordinates for one or more vehicles from a plurality of vehicles, wherein each vehicle is equipped with a receiver for a global navigation satellite system (GNSS) and the ability to compute position using GNSS pseudoranging data, the method comprising:
a) determining a first set of GNSS satellites in view for the first vehicle;
b) determining a second set of GNSS satellites in view for the second vehicle;
c) determining a first subset of GNSS satellites that are common to both the first set and second set of GNSS satellites; and
d) relying, by the first vehicle, on pseudoranging data from the first subset of GNSS satellites to compute position.

2. The method of claim 1, wherein
the determined position coordinates are relative position coordinates for the one or more vehicles.

3. The method of claim 1, additionally comprising
relying, by at least one of the first vehicle and the second vehicle,
only on pseudoranging data from the first subset of GNSS satellites to compute velocity.

4. The method of claim 3, wherein
the computed velocity is a relative velocity.

5. The method of claim 1, wherein
step a) occurs on the first vehicle; and
step b) occurs on the second vehicle.

6. The method of claim 5, wherein
step c) occurs on the first vehicle;
the method additionally comprising:
wirelessly transmitting identifiers for the second set of GNSS satellites from the second vehicle to the first vehicle; and
sharing the first subset of GNSS satellites with the second vehicle.

7. The method of claim 5, wherein
step c) occurs on both the first vehicle and the second vehicle;
the method additionally comprising:
wirelessly transmitting identifiers for the second set of GNSS satellites from the second vehicle to the first vehicle;
wirelessly transmitting identifiers for the first set of GNSS satellites from the first vehicle to the second vehicle.

8. The method of claim 1, wherein the first vehicle relies only on pseudoranging data from the first subset of GNSS satellites to compute position.

9. The method of claim 1, further comprising:
relying, by the second vehicle, only on pseudoranging data from the first subset of GNSS satellites to compute position.

10. The method of claim 1, wherein
step a) occurs on the first vehicle;
step b) occurs on the second vehicle; and
step c) occurs at a remote network operations center (NOC);
the method additionally comprising:
transmitting the first set of GNSS satellites wirelessly from the first vehicle to the remote NOC;
transmitting the second set of GNSS satellites wirelessly from the second vehicle to the remote NOC; and
transmitting a message from the remote NOC to at least one of the first vehicle and second vehicle, the message identifying the first subset of GNSS satellites.

11. The method of claim 10, wherein
the message identifying the first subset of GNSS satellites is transmitted from the remote NOC to the first vehicle, the method further comprising relaying the message from the first vehicle to the second vehicle.

12. The method of claim 10, wherein
the message identifying the first subset of GNSS satellites is transmitted from the remote NOC to each of the first vehicle and the second vehicle.

13. The method of any of claim 8, additionally comprising:
storing the first set of GNSS satellites and
the second set of GNSS satellites
at the NOC.

14. The method of claim 1, wherein
the method is repeated on a regular time interval.

15. The method of claim 1, wherein
the first vehicle and the second vehicle are capable of travelling in a platoon.

16. The method of claim 1, wherein
the first vehicle and the second vehicle are travelling in a platoon, and have established a short-range communication link to exchange data between them.

17. The method of claim 17, in which
the short-range communication link is a DSRC channel.

18. The method of claim 1, wherein
the GNSS is the Global Positioning System (GPS).

19. A system for determining position coordinates for a vehicle, wherein the vehicle is equipped with a receiver for a global navigation satellite system (GNSS) and the ability to compute position using GNSS pseudoranging data, and is also linked to a one or more other vehicles using a vehicle-to-vehicle (V2V) communication link, the method comprising:
a) determining a first set of GNSS satellites in view for the vehicle;
b) receiving information describing a second set of GNSS satellites in view for the one or more vehicles via the V2V communication link;
c) determining a first subset of GNSS satellites that are common to both the first set and second set of GNSS satellites;
d) relying only on pseudoranging data from the first subset of GNSS satellites to compute position.

20. A computer readable medium storing instructions to cause a processor to perform operations comprising
a method for determining position coordinates for one or more vehicles from a plurality of vehicles, wherein each vehicle is equipped with a receiver for a global navigation satellite system (GNSS) and the ability to compute position using GNSS pseudoranging data, the method comprising:
a) determining a first set of GNSS satellites in view for the first vehicle;
b) determining a second set of GNSS satellites in view for the second vehicle;
c) determining a first subset of GNSS satellites that are common to both the first set and second set of GNSS satellites;
d) relying, by the first vehicle, only on pseudoranging data from the first subset of GNSS satellites to compute position; and
e) relying, by the second vehicle, only on pseudoranging data from the first subset of GNSS satellites to compute position.
